(19) United States
(12) Patent Application Publication
(10) Pub. No.: US 2017/0219130 A1
(43) Pub. Date: Aug. 3, 2017

(54) Surface mount with limits to four degrees of freedom.

(71) Applicant: Christopher Adam McLeod, Toronto (CA)

(72) Inventor: Christopher Adam McLeod, Toronto (CA)

(21) Appl. No.: 15/012,814

(22) Filed: Feb. 1, 2016

(51) Int. Cl. F16L 5/08; E03F 5/04

(52) U.S. Cl. CPC F16L 5/08; E03F 5/0408; E03F 5/0409

(57) ABSTRACT

A flanged pipe is mounted to a perforated fixed plate by limiting movement of the pipe in three mutually perpendicular axes, and rotationally around the plate axis. The mount consists of a plate and a flanged pipe. The pipe exterior is decorated with ribs parallel to the pipe axis. Each rib bears a microclip positioned to allow the plate to rest between the pipe rib microclips and the underside of the pipe flange. The perimeter of the plate perforation bears cutaways. Inserting the pipe through the perforation of the fixed plate engages the ribs with the cutaways to limit rotational movement. Movement in the plane perpendicular to the plate axis is limited by complementary diameters of the plate perforation and the pipe. Engagement of the flange on the plate limits movement of the flanged pipe through the plate perforation. Pipe retraction is limited by microclips.

### FIELD OF THE INVENTION

The present invention relates generally to surface mounts, and more particularly surface mounts to further mount a device such as but not restricted to a threaded shower drain or a mounted seal. A surface mount requires a substantially planar surface such as a floor or a wall to which to be mounted. Said mount is fixed to a surface by a plurality of means including screws that are passed through holes in the plate outer perimeter to fasten it to the floor. In so doing, a plurality of devices may be further fixed to the fixed mounting plate by devices such as threadmates or bayonet mounts. However, materials such as stamped steel suited to the fabrication of mounting plates may be unsuited to bearing threads for a plurality of reasons including cost of fabrication method. Accordingly, a mounting part made of a material more suited to bearing mounting devices including threads can be fixed to said mounting plate. Said mounting part can include a variety of mounting utilities, but one of the most common in plumbing and electrical work is a flanged pipe with an internal thread. If the surface to which the mounting plate is perforated, and said mounting plate is also perforated, and said mounting plate is fixed to the surface by a plurality of means including screws such that the mounting plate perforation shares a central axis with the central axis of the perforation of the surface, then the mounting plate can be used to further mount a mounting part bearing the necessary hubs and internal threads to act as a connector for, including but not restricted to, plumbing pipe or electrical conduit. The act of securing involves limiting degrees of freedom of movement of the flanged pipe relative to the mounting plate fixed to a perforated surface such as a floor.

### BACKGROUND OF THE INVENTION

A flanged pipe mounted to a plate in turn mounted to a surface such as a floor is a means whereby a pipe or conduit may be connected across a barrier such as presented by the floor to a pipe or conduit beneath the floor. In plumbing, said flanged pipe may be internally threaded, wherein said internal threading starts at the flange upper surface and cuts down helically inside the internal perforation of the pipe. A threaded part, such a shower drain grate support or a mounted seal, can then be threaded into the mount. This mounting will be secure only if the flanged threaded pipe cannot move in the three mutually perpendicular axes as well as not rotate around the axis of the flanged pipe, that is, movement is limited in four degrees of freedom. Hitherto said mounting has required multiple parts and fasteners in multiple materials.

In contrast, the Invention presented in this application achieves fixing of said flanged pipe to said fixed mounting plate, with no extra parts, to achieve limitation of movement in the plane parallel with the mounted surface, to achieve limitation of movement in the axis perpendicular to said mounted surface, and to achieve limitation of movement rotationally around the axis of the flanged pipe.

### SUMMARY OF THE INVENTION

A flanged pipe is mounted to a perforated fixed plate by limiting movement of the pipe in three mutually perpendicular axes, and rotationally around the plate axis. The mount consists of said mounting plate and said flanged pipe. The flanged pipe exterior is decorated with ribs parallel to the pipe axis. Each rib bears a microclip positioned to allow the plate to rest between the pipe rib microclips and the underside of the pipe flange. The perimeter of the central perforation of the plate bears indexing cutaways matching the size and positioning of the ribs on the flanged ribbed pipe. Inserting said flanged ribbed pipe through the perforation of the fixed plate engages the ribs with the indexing cutaways to limit rotational movement. Movement in the plane perpendicular to the plate axis, and parallel to said mounted surface, is limited by the tightly fitting diameters of the plate perforation and the pipe portion of the flanged ribbed pipe. Engagement of the flange on the plate limits movement of the flanged pipe through the plate perforation. Pipe retraction is limited by microclips.

A third part may be added to this assembly to achieve seal to liquids or gases. An annular seal, either loose or attached to the underside of the flange of the flanged ribbed pipe, is positioned to the underside of the flange in a flanged ribbed pipe equipped with microclips. Upon forcibly inserting the registered pipe into the central perforation of the mounting plate as decorated with cutaways, the pipe passes over the microclips, sandwiching the seal in between the underside of the flange of the flanged ribbed pipe and the inner perimeter of the mounting plate to achieve a bound and complete seal. The microclips lock the plate to the seal.

A practical implementation of said surface mount is to mount the plate to a bathroom subfloor with screws such that a precut or preformed hole in the surface shares a collinear axis as the perforation in the plate. Upon mounting of the flanged ribbed pipe with seal to the plate, a shower drain or mounted seal may be threaded into an internal thread in the upper area of the central perforation of the flanged ribbed pipe. Finishing decoration such as tiling may then ensue.

### BRIEF DESCRIPTION OF THE DRAWINGS

FIG. 1(a) is an isometric view of the surface mounted, and (b) is a cross section of the mount showing the mounting plate, the flanged threaded pipe, and the sandwiched seal.

FIG. 2 is a top view of the mounting plate showing the central perforation, cutaways around the perimeter of the internal perforation, and perforations around the outer perimeter of the plate to allow fixing of the plate to a perforated surface by fasteners such as screws.

FIG. 3 is a lateral view of a cross section of the flanged ribbed pipe showing flange, ribs, microclips, and an internal thread for further mounting a devices such a mounted seal, and a hub for attaching further pipe distal to the flange end of said flanged ribbed pipe.

FIG. 4 (a) is a lateral view of the surface mount, and (b) is a lateral view of a detail of a cross section of the locking device comprised by the microclips locking the mounting plate between the flange of the flanged pipe and the microclips.

FIG. 5 is a trimetric view of a seal mount mounted in the surface mount, illustrating one embodiment of the surface mount serving as a thread mount for a mounted seal equipped with a removable air seal. The limitation of movement in the surface mount is crucial for the mounted seal to function as an immobile mounted seal for a pipe tailpiece of a bath, but this is only one embodiment of the utility of the surface mount 7.

### DETAILED DESCRIPTION OF THE INVENTION

Before describing in detail exemplary embodiments that are in accordance with the present invention, it should be observed that embodiments reside primarily in combinations of structural components and installation and use steps related to implementing apparatus and methods for a mounting assembly which defines a perforation which is adapted to be placed in registry with a floor or other drain conduit so that said mounting assembly is sufficiently limited to securely serve as a mount for an additional device to be connected to said floor or other drain conduit. A perforated mounting plate in the surface mount assembly is associated with a flanged ribbed pipe in said assembly in such a way that (i) insertion of a flanged ribbed pipe into the perforation of the mounting plate is limited by a flange on the flanged ribbed pipe; (ii) movement in the plane perpendicular to the pipe axis is limited by the tightly matched diameters of the central perforation of the mounting plate and the pipe portion of the flanged ribbed pipe; (iii) retraction of said flanged ribbed pipe from the perforation is limited by the action of microclips; (iv) rotation around the axis of the flanged ribbed by is limited by the indexing of ribs parallel to the axis of said flanged ribbed pipe with cutaways in the internal perimeter of the mounting plate to fully and securely mount the mounting assembly to the mounted surface.

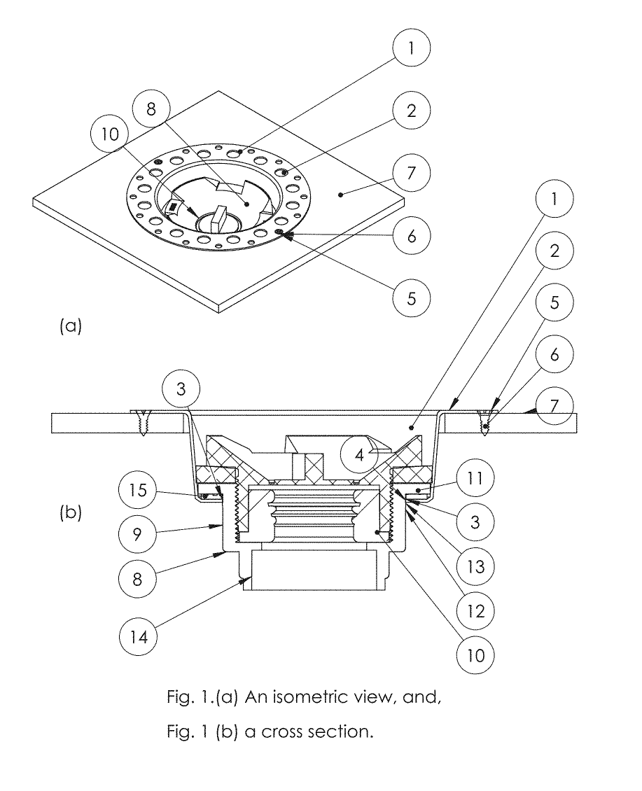

FIG. 1(a) presents an isometric view of the surface mount 1 mounted in a surface 7 with a plurality of fasteners 6 fastening the mounting plate 2 through perforations 5 in said plate 2 to the surface 7. A flanged ribbed pipe 8 with internal threading 10 is locked into the mounting plate 2. FIG. 1(b) presents a cross section of the surface mounts 1 showing the plate 2 perforated by a central perforation 3, cutaways 4 around the internal perimeter of said central perforation 3, and perforations 5 for fasteners 6 to mount the plate 2 to the surface 7. An internally threaded flanged ribbed pipe 8 with microclips displays an upper internal thread 10, a flange 11, ribs 12, and microclips 13 on said ribs 12 on the upper pipe portion 9. The central perforation of said flanged ribbed pipe 8 has a pipe hub 14 at the bottom in order to connect the mount to an underlying pipe or conduit system, said hub 14 optionally bearing an internal thread in another embodiment. An optional seal 15 is sandwiched between the flange 11 of the flanged ribbed pipe 8 and the plate 2.

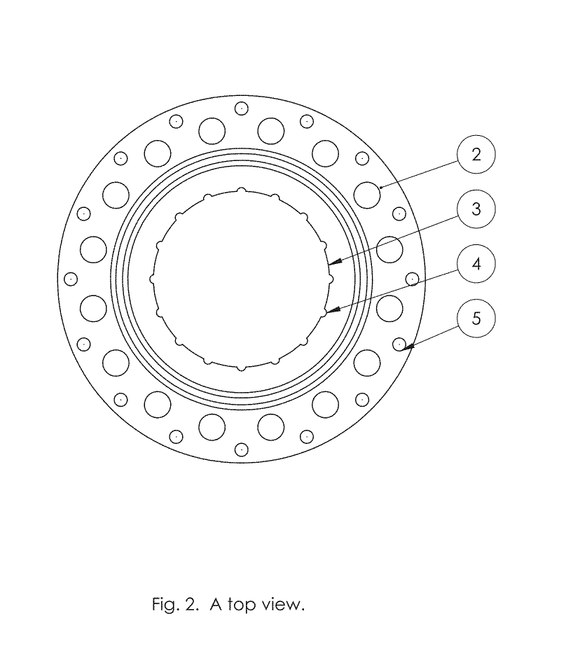

FIG. 2 presents a top view of the mounting plate 2 with a central perforation 3, cutaways 4 around the internal perimeter of said central perforation 3, and perforations 5 for fasteners to mount the plate 2 to a surface.

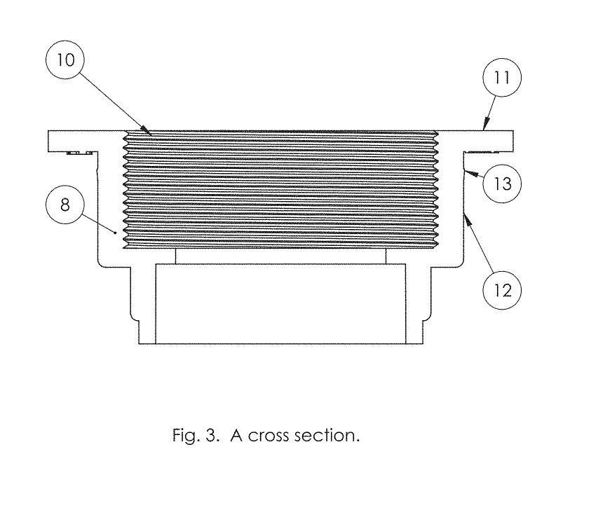

FIG. 3 presents a lateral view of a cross section of a flanged ribbed pipe 8 showing an upper internal thread 10 for mounting a device including but not restricted to a shower grate support or a mounted seal for a pipe. The flange 11 acts as an insertion limiter, and the ribs 12 index with cutaways in the mounting plate. The microclips 13 lock the flanged ribbed pipe 8 to a mounting plate.

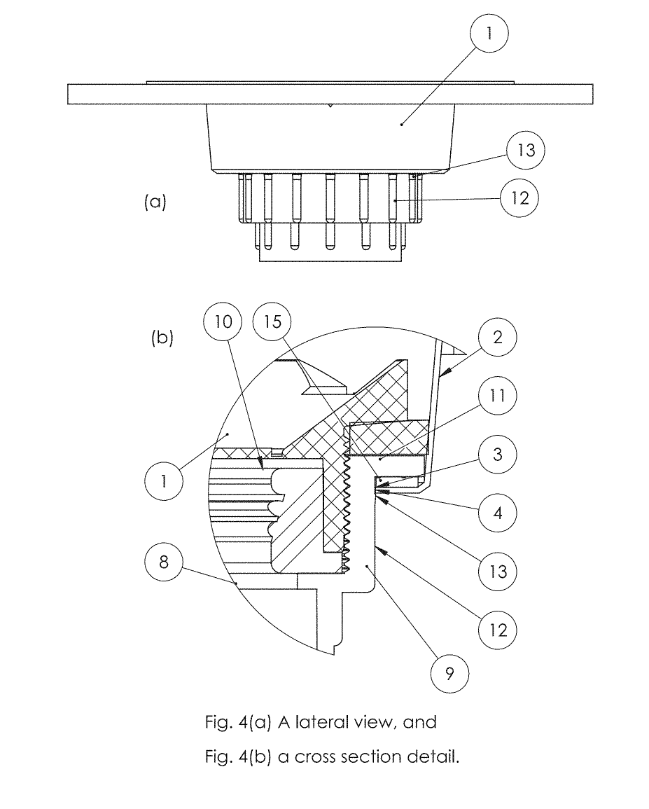

FIG. 4(a) presents a lateral view of the surface mount 1 showing ribs 12 and microclips 13. FIG. 4(b) presents a detail from a cross section of the surface mount assembly 1 showing the plate 2 perforated by a central perforation 3, cutaways 4 around the internal perimeter of said central perforation 3. An internally threaded flanged ribbed pipe 8 with microclips displays an upper internal thread 10, a flange 11, ribs 12, and microclips 13 on said ribs 12 on the upper pipe portion 9. Said flanged ribbed pipe 8 is forcibly inserted into the plate 2 by aligning the ribs 12 with the indexing cutaways 4, and pushing such that the microclips 13 pop past the plate 2 and in so doing lock the plate 2 to the flanged ribbed pipe 8, optionally sandwiching a seal 15.

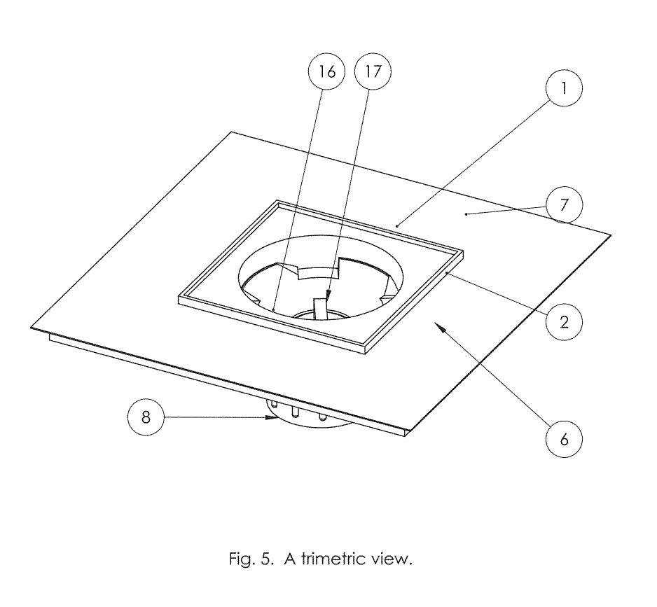

FIG. 5 presents a trimetric view of the surface mount 1 mounted on a surface 7, in this case a perforated wood deck, showing the mounting plate 2 fastened to the surface 7 by a plurality of fasteners 6. In this embodiment, a seal mount 16 with a removable air seal 17 has been threaded into the internal thread in the upper inner surface of the flanged ribbed pipe 8 presented by the surface mount 1, illustrating one embodiment of the utility of a surface mount.

1. A surface mount assembly to which devices may be attached, comprising:
a mounting plate equipped with perforations around its outer perimeter to allow fixing to a perforation in a surface by a plurality of fasteners including screws, said mounting plate having a central perforation being of a diameter to just allow passing of the pipe portion of a ribbed flanged pipe, and having cutaways on the inner perimeter of the central perforation sized and located to allow indexing with the ribs, wherein:
the flanged pipe is mountable to a mounting plate such that the underside surface of the flange of the flanged pipe engages with the inner perimeter of the central perforation in the mounting plate and the ribs engage with cutaways in said inner perimeter of the central perforation of the mounting plate.

2. The overlying mounting assembly as claimed in claim 1 further comprising microclips where a microclip comprises a bump on each rib that is located at a distance from the underside of the flange sufficient to accommodate the thickness of the mounting plate and an optional seal between the underside of the flanged ribbed pipe flange and the microclip, wherein:
said flanged ribbed pipe is forcibly inserted into a mounting plate such that the inner perimeter of the plate, indexed by the pipe ribs and plate cutaways, is forced over the microclip bump on each rib, locking the plate between the flange of the flanged ribbed pipe and the microclips.

3. The overlying drain assembly as claimed in claim 2 further comprising an optional annular seal located on the underside of the flange of the flanged ribbed pipe, said seal being separate or attached to the flange by a plurality of means, wherein:
said seal is sandwiched between the underside of the flanged ribbed pipe when the flanged ribbed pipe is inserted through and locked into the mounting plate by virtue of the microclips, to form a seal to gases or liquids.

4. The overlying drain assembly as claimed in claim 1 further comprising an internal thread inscribed in the upper interior of the central perforation of a flanged ribbed pipe, wherein:
said internal thread can be used for mounting a further device.
